(19) United States
(12) Patent Application Publication
(10) Pub. No.: US 2015/0371162 A1
(43) Pub. Date: Dec. 24, 2015

(54) SYSTEM AND METHOD FOR IDENTIFYING ENTERPRISE RISKS EMANATING FROM SOCIAL NETWORKS

(71) Applicant: Cognizant Technology Solutions India Pvt. Ltd., Chennai, TN (US)

(72) Inventors: Jai Ganesh, Bangalore (IN); Bharadwaj Raghuraman, Bangalore (IN)

(21) Appl. No.: 14/505,720

(22) Filed: Oct. 3, 2014

(30) Foreign Application Priority Data
Jun. 18, 2014 (IN) 2966/CHE/2014

(51) Int. Cl. G06Q 10/06; G06Q 50/00

(52) U.S. Cl. CPC G06Q 10/0635; G06Q 50/01

(57) ABSTRACT

A computer-implemented method and a system for identifying one or more enterprise risks emanating from one or more social networks are provided. In various embodiments of the present invention, interaction data of one or more users of the one or more social networks are aggregated. The aggregated interaction data and one or more predefined keywords relating to the one or more enterprise risks are employed to identify one or more communities of users interacting in a predetermined time period. One or more non-active users are iteratively eliminated from the one or more communities and interaction data of remaining users are analyzed for identifying the one or more enterprise risks.

### CROSS REFERENCE TO RELATED APPLICATION

This application is related to and claims the benefit of Indian Patent Application Number 2966/CHE/2014 filed on 18 Jun. 2014, the contents of which are herein incorporated by reference in their entirety.

### FIELD OF THE INVENTION

The present invention relates generally to the field of enterprise risk management and more particularly to a system and method for identifying enterprise risks emanating from social networks.

### BACKGROUND OF THE INVENTION

Business entities and enterprises are often associated with a significant number of risks that can put adverse impact on the entire enterprise. Identifying and monitoring risks within an enterprise is a critical requirement as it enables the enterprise to prevent losses and achieve its objectives successfully.

Many a time, enterprises risks emerge through social networks such as Facebook, Twitter, Sina Weibo etcetera. Users of the social networks interact with each other by sharing their thoughts, knowledge, and other information and also form groups or communities to discuss over common subjects. These discussions may include information regarding one or more companies, organization, institutions, products and events such as good or bad features of a product, ratings or complains of a product, malpractices of any company, factory or organization etcetera. Such type of discussions on social networks gain rapid momentum over a period of time and emerge as serious risks to the enterprises.

Therefore it is essential for an enterprise to monitor and analyze the discussion trends on the social networks so that enterprise risks can be identified and curative measurements can be taken.

Various approaches are known in the art for identifying and analyzing the social network discussion trends in order to measure enterprise risks. These include clique-based, degree-based, and matrix-perturbation based methods that generally identify communities or groups of users participating in the social networking activities. However, these approaches focus on identifying communities or cliques on static networks only and fail to analyze dynamic structures of the social networks.

Other approaches are also known in the art that detect communities in dynamic networks. However, the communities in dynamic social networks also contain non-active users who do not contribute substantially to the enterprise risks. The existing solutions are not well equipped to precisely recognize the ‘key’ users of the communities who are majorly involved in contributing to the enterprise risks.

In light of the above, there is a need for a system and method to identify the enterprise risks emanating from one or more dynamic social networks. Further, there is a need for a system and method to identify and monitor complex dynamic social networks that change over time. Furthermore, there is a need for a system and method to identify behavior and pattern of the social interactions of users in the dynamic social networks. In addition, there is a need for a system and method to identify and monitor core community structures that substantially contribute to the enterprise risks over a period of time.

### SUMMARY OF THE INVENTION

A computer-implemented method and a system for identifying one or more enterprise risks emanating from one or more social networks are provided.

The computer-implemented method comprises the steps of aggregating interaction data of one or more users of the one or more social networks; employing the interaction data and one or more predefined keywords relating to the one or more enterprise risks to identify one or more communities of users interacting in a predetermined time period; eliminating iteratively from the one or more communities, one or more non-active users interacting least in the predetermined time period; and analyzing the interaction data of remaining users for identifying the one or more enterprise risks during the predetermined time period. The one or more enterprise risks are identified by creating graphs that depict pattern of the interaction data of users within the one or more identified communities.

In an embodiment of the present invention, analyzing of the interaction data further comprises the steps of monitoring pattern of the interaction data of users over the predetermined time period, and identifying and monitoring one or more profiles of users within the one or more communities that are of potential risk to one or more enterprises.

The system for identifying one or more enterprise risks emanating from one or more social networks comprises a processor, a data integrator, a keyword module, a data analysis module, a risk identifying module. The processor executes program instructions stored in a memory to configure the data integrator, the keyword module, the data analysis module, and the risk identifying module.

The data integrator is configured to aggregate interaction data of one or more users of the one or more social networks. The keyword module is configured to provide one or more predefined keywords relating to one or more enterprise risks. The data analysis module is configured to employ the interaction data and the one or more predefined keywords to identify one or more communities of users interacting in a predetermined time period, and iteratively eliminate one or more non-active users from the one or more communities, who interact the least in the predetermined time period. The risk identifying module is configured to analyze the interaction data of remaining users to identify the one or more enterprise risks during the predetermined time period. The one or more enterprise risks are identified by creating graphs that depict behaviors and pattern of the interaction data of users within the one or more communities.

In various embodiments of the present invention, the one or more predefined keywords are created using taxonomy of the one or more enterprise risks.

In various embodiments of the present invention, the one or more communities comprise groups of users, subgroups of users, and individual users. The groups of users, the subgroups of users, and individual users are dynamic in number. Further, the groups and subgroups of users are linked to each other based on common user-interests.

In various embodiments of the present invention, the data analysis module is further configured to monitor pattern of the interaction data of users over the predetermined time period, and to identify and monitor one or more profiles of users within the one or more communities that are of potential risk to one or more enterprises.

In various embodiments of the present invention, the remaining users are identified as active users by setting a threshold. The threshold is based upon one or more factors including but is not limited to the prescribed time, number of the interaction data posted by the one or more users, relevancy of the interaction data with respect to the one or more predefined keywords, structure of the one or more social networks, and range of the one or more social networks.

A computer program product for identifying one or more enterprise risks emanating from one or more social networks is provided. The computer program product comprises a non-transitory computer-readable medium having computer-readable program code stored thereon, the computer-readable program code comprising program instructions that when executed by a processor, cause the processor to: aggregate interaction data of one or more users of the one or more social networks; employ the interaction data and one or more predefined keywords relating to the one or more enterprise risks to identify one or more communities of users interacting in a predetermined time period; eliminate iteratively from the one or more communities, one or more non-active users interacting least in the predetermined time period; and analyze the interaction data of remaining users for identifying the one or more enterprise risks during the predetermined time period.

The program instructions further cause the processor to monitor pattern of the interaction data of users over the predetermined time period, and identify and monitor one or more profiles of users within the one or more communities that are of potential risk to one or more enterprises.

### BRIEF DESCRIPTION OF THE ACCOMPANYING DRAWINGS

The present invention is described by way of embodiments illustrated in the accompanying drawings wherein:

FIG. 1 is a block diagram illustrating a system for identifying enterprise risks emanating from social networks in accordance with an embodiment of the present invention;

FIG. 2 is a detailed block diagram of a risk data processing module in accordance with an embodiment of the present invention;

FIG. 3 illustrates evolution of enterprise risk related communities in accordance with an embodiment of the present invention;

FIGS. 4A and 4B represent a flowchart illustrating a method for identifying enterprise risks emanating from social networks in accordance with an exemplary embodiment of the present invention;

FIG. 5 illustrates an exemplary computer system in which various embodiments of the present invention may be implemented.

### DETAILED DESCRIPTION OF THE INVENTION

A system and a method for identifying one or more enterprise risks emanating from one or more social networks are described herein. The invention provides for a system and method that employ interaction data and one or more predefined keywords to identify one or more communities of users interacting in a predetermined time period. The invention further provides for a system and method that can eliminate iteratively one or more non-active users from the one or more communities identified. Furthermore, the invention provides for a system and method that can analyze interaction data of the active users during the predetermined time period to identify the one or more enterprise risks.

The following disclosure is provided in order to enable a person having ordinary skill in the art to practice the invention. Exemplary embodiments are provided only for illustrative purposes and various modifications will be readily apparent to persons skilled in the art. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

The present invention would now be discussed in context of embodiments as illustrated in the accompanying drawings.

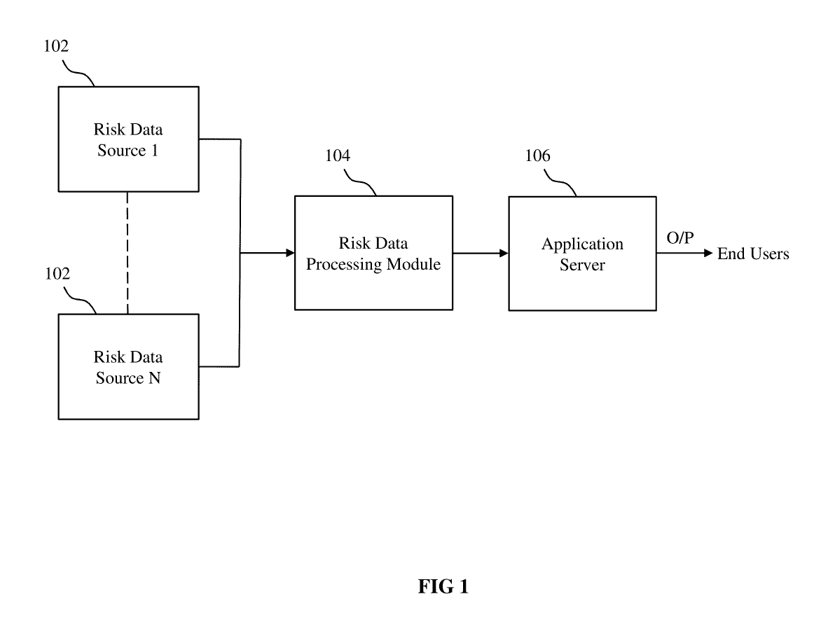

FIG. 1 is a block diagram illustrating a system for identifying enterprise risks emanating from social networks in accordance with an embodiment of the present invention. The system 100 comprises one or more risk data sources 102, a risk data processing module 104 and an application server 106.

The one or more risk data sources 102 are one or more social networks facilitating one or more users to post their social networking messages and interaction data with each other. The one or more risk data sources 102 include a plurality of online social networks, social media networks or systems, websites, and computer enabled systems including for example; Facebook, Twitter, Sina Weibo, and any other similar social networks or websites. One or more users access the one or more social networks for posting, commenting, blogging, sending messages, expressing, sharing views on subject of interest, creating groups, creating communities or forums that link or connect people having common or similar interests. Further, the one or more users access the one or more online social networks using one or more communication devices including, but not limiting to, a personal computer (PC), a mobile phone, a Personal Digital Assistant (PDA), a smart phone, and any other communication device.

The one or more risk data sources 102 are accessed by the one or more users and consequently interaction data shared or posted by the one or more users may be collected for performing risk analysis for one or more enterprises. The risk data processing module 104 aggregates interaction data from the one or more risk data sources 102 and processes the aggregated interaction data to identify one or more risks for one or more enterprises. The risk data processing module 104 can be accessed by one or more authorized end users through the application server 106 for identifying enterprise risks emanating from the one or more data sources 102 including the one or more social networks.

In one embodiment of the present invention the application server 106 is a server, web server or a system that provides necessary hardware and software platform to the risk data processing module 104. The application server 106 also provides authentication to one or more end users. The one or more end users logs into the application server 106 and after authentication, authorized end users are allowed secure access to the risk data processing module 104.

The one or more end users are enterprise risk monitoring team or individuals intending to monitor enterprise risks emanating from the one or more social networks according to their requirement. In an embodiment of the present invention, the requirement of the one or more end users includes but not limited to enterprise risk management, risk measurement and calculation, quality control etcetera. Further, the application server 106 is configured to provide secure access to the risk data processing module 104 to the one or more authorized end users through one or more electronic devices including, but not limited to, a personal computer (PC), a mobile phone, a Personal Digital Assistant (PDA), a smart phone, a television set, a wearable electronic device and any other appropriate electronic device. In one embodiment of the present invention, the application server 106 hosts the risk data processing module 104. In another embodiment of the present invention, the risk data processing module 104 is at a location remote to the application server 106.

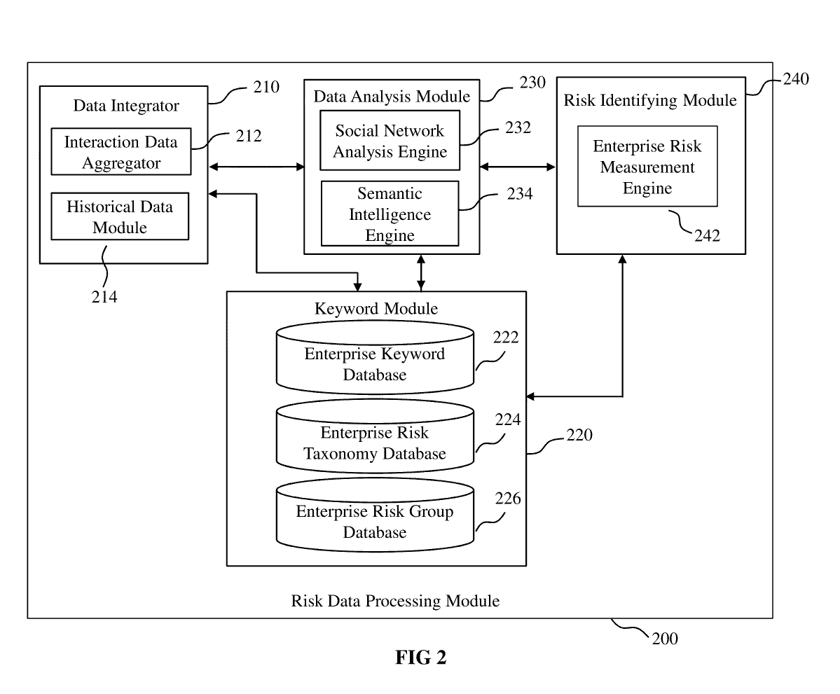

FIG. 2 is a detailed block diagram of the risk data processing module in accordance with an embodiment of the present invention. The risk data processing module 200 comprises a data integrator 210, a keyword module 220, a data analysis module 230, and a risk identifying module 240.

The data integrator 210 is a data aggregating module that collects and integrates data from the one or more risk data sources 102 (FIG. 1). In one embodiment of the present invention the data integrator 210 comprises an interaction data aggregator 212 and a historical data module 214. The interaction data aggregator 212 collects social networking data from the one or more data sources including one or more social networks, systems, and websites. One or more users access the one or more social networks and provide interaction data including but not limited to posts, comments, blogs, messages, conversations, and any views or expressions relating to any matter of interest. Further, the one or more users also access the one or more social networks to create one or more groups, communities, cliques or forums. The one or more groups, communities, cliques, or forums connect together the users or people who share interaction data relating to common subject within the respective communities, groups, cliques or forums. The communities, groups, cliques or forums herein after will be referred to as ‘communities’ throughout this specification. The one or more communities may post interaction data pertaining to one or more enterprise risks on the one or more social networks. The interaction data pertaining to one or more enterprise risks may for example include information pertaining to defamation posts or internet libels for any company, organization, institution, products, brands; ratings or complaints of a product; malpractices of any company, factory, or organization etcetera are shared by the communities across the one or more social networks and collected by the interaction data aggregator 210.

The historical data module 214 is a database storing historical data. The historical data may include enterprise risks data of previously identified communities or groups. The historical data may be obtained after performing analysis of previous data available with the communities for any enterprise. The previous data available may include for example: data of a Non-Governmental Organization (NGO), details of logins such as profile data of group members, interaction data of group members and so on. The data integrator 210 aggregates interaction data and historical data from interaction data aggregator 212 and the historical data module 214 respectively.

The keyword module 220 comprises an enterprise keyword database 222, an enterprise risk taxonomy database 224 and an enterprise risk group database 226. The enterprise keyword database 222 stores one or more predefined keywords related to one or more enterprises. The enterprise keyword database 222 stores one or more keywords related to for example, ‘enterprise name’, ‘brand’, ‘product’, and ‘enterprise service’ etcetera. The enterprise taxonomy database 224 stores one or more predefined keywords related to one or more enterprises risks. The enterprise taxonomy database 224 creates taxonomy of one or more enterprise-risks-constructs wherein each enterprise-risks-construct is a keyword or a keyword string pertaining to the enterprise risks. Each enterprise-risks-construct is also associated with one or more variables. The enterprise taxonomy database 224 creates one or more keywords pertaining to the one or more variables.

For example, an enterprise-risk-construct may include, ‘Operational Risk’, and the enterprise risk variable related to the enterprise-risk-construct ‘Operational Risk’ may include ‘Product Risk’. The variable ‘Product risk’ may depict malfunctioning of a product component. Therefore, the associated enterprise risk keywords for the above example may include ‘failure’, ‘slow’, ‘sucks’, ‘refund’, ‘return’, ‘unhappy’ etcetera. These keywords may be created and stored in the enterprise risk taxonomy database 224. Similarly, other enterprise risk constructs, associated variables and related keywords may be created/generated and stored in the enterprise taxonomy database 224.

The enterprise risk group database 226 stores one or more keywords related to risky groups that preexist and are popularly known, or are recently formed. The one or more keywords related to risky groups can be generated after historical analysis of the preexisting risky groups and analysis of the newly identified risky groups. The risky groups may include pressure groups for example ‘Greenpeace’, ‘NGOs’, ‘Lobbyists’ etcetera. The one or more keywords related to risky groups may be updated on a regular interval. In one embodiment of the present invention the enterprise keyword database 222, the enterprise risk taxonomy database 224 and the enterprise risk group database 226 may be updated regularly by the end users via the application server 106 (FIG. 1).

The data analysis module 230 comprises a social network analysis engine 232 and a semantic intelligence engine 234. In one embodiment of the present invention the social network analysis engine 232 receives social interaction data from the data integrator 210 and predefined keywords from the keyword module 220. The social network analysis engine 232 matches the interaction data with the predefined keywords to perform risk analysis. In one embodiment of the present invention the risk analysis is performed for a predetermined time period or a time window provided by the one or more end users. For each time period, a separate analysis is performed by obtaining the interaction data from the data integrator 210 and analyzing the data for that time period in the social network analysis engine 232. As mentioned above, the interaction data pertains to one or more enterprise risks which are identified by performing data mapping on the interaction data i.e. matching the interaction data with predefined keywords received from the keyword module 220. Further, in each predetermined time period, one or more communities comprising one or more active users who contribute the most to the enterprise risks are identified by the social network analysis engine 232. The one or more communities comprising active users are discovered using clustering of individuals based on their similarities of patterns of interactions with other individuals in the community around the taxonomy defined in the enterprise risk taxonomy database 224.

The semantic intelligence engine 234 also receives social interaction data from the data integrator 210 and predefined keywords from the keyword module 220. The semantic intelligence engine 234 identifies one or more predefined keywords that are used repeatedly in the interaction data and appear in the interaction data with special repetition, or arrangement of words. The semantic intelligence engine 234 further performs semantic analysis of the repeatedly being used keywords for identifying relationship between words, phrases, clauses, sentences, paragraphs, signs and symbols. The semantic intelligence engine 234 also places synonyms of the repeatedly being used keywords in the enterprise risk group database 226. The semantic intelligence engine 234 further provides relative meanings to elements of idioms and phrases occurring in the interaction data. The output of the semantic intelligence engine 234, inter-alia is used by the social network analysis engine 232 for identifying the one or more communities of active users who contribute to enterprise risks.

The risk identifying module 240 comprises an enterprise risk measurement engine 242. The enterprise risk measurement engine 242 sets a threshold for identifying one or more communities comprising active users who contribute the most to the enterprise risk. In one embodiment of the present invention the threshold is based upon one or more factors including but not limited to the prescribed time, number of interaction data posted by the one or more users, relevancy of the interaction data with respect to the one or more predefined keywords, structure of the one or more social networks, and range of the one or more social networks. The one or more communities of active users are identified by iteratively eliminating one or more non-active users from the one or more identified communities of users. As explained above, the one or more communities of users are identified by the social network analysis engine 232. Further, the iterative elimination of non-active users, who contribute the least to the enterprise risks, is processed based on the set threshold. The threshold therefore characterizes ‘a core community’ with active users wherein the members of the core community are active and consistent and have a consistently observable and measurable network structure, and a substantial range of network centrality measures across the predetermined time periods.

In one embodiment of the present invention, the enterprise risk measurement engine 242 is configured to iteratively eliminate non-active users from the one or more identified communities by firstly, characterizing the evolution of identified communities as convergent, divergent, closed, open, evolving etcetera. The evolution of the identified communities involves entries of new members and departures of former members of the one or more identified communities over a period of time. During the evolution of one or more communities, some members become inactive and do not contribute to enterprise risks. The non-active users are removed from the community, and only the active users who contribute the most to the risky interaction data related to an enterprise across the one or more social networks are retained. Secondly, the interaction data of non-active users is trimmed and the process is iterated till there is stability in the number of active community individuals or users. For example, the evolution of risk for an enterprise brand can be measured by collecting data on each of the users who posted a message regarding the brand in conjunction with the set of risk denoted keywords. In order to measure the continuation of risk, the enterprise risk measurement engine 242 eliminates all users who posted interaction data only once or did not post again after the predetermined time period from their initial message. The enterprise risk measurement engine 242 thus discards users who post interaction data in an impulsive manner, and also discards interaction data of such users. The remaining users are analyzed and identified as the active users, and the community is identified as the core community or the clique. The interaction data of the core community is analyzed based on frequency of words in the interaction data for determining topics of interaction and subsequently calculating or measuring the enterprise risk. The enterprise risk events may include for example; a product recall, or a quality problem with product. The enterprise risk measurement engine 242 is configured to select the measured enterprise risk events in order to compare the pre and post volumes of the users discussing the event. This facilitates the end user to identify the key users or the active users in the networks who sustained their interest in the event creating further conversations and prolonged exposure for the enterprise. The overall risk for an enterprise brand is subsequently determined by analyzing interaction data of the active users.

The enterprise risk measurement engine 242 is further configured to develop a measure for dynamic network structure of risk data sources 102 (FIG. 1). The dynamic network structure of risk data sources 102 (FIG. 1) has dynamic or fluctuating number of users over a period of time. The enterprise risk measurement engine 242 monitors similarity of clusters over the predetermined time period depending on the sizes of both the clusters that are connected and also of the clusters that are accounting temporal changes. The enterprise risk measurement engine 242, thus measures dynamic network structure by monitoring temporal fluctuations of the users in a cluster or community. The dynamic network structure is measured by monitoring participation of members who can be active users or key users, and also monitoring departures of current active users from the communities over time with a proportion as defined using threshold by the end user.

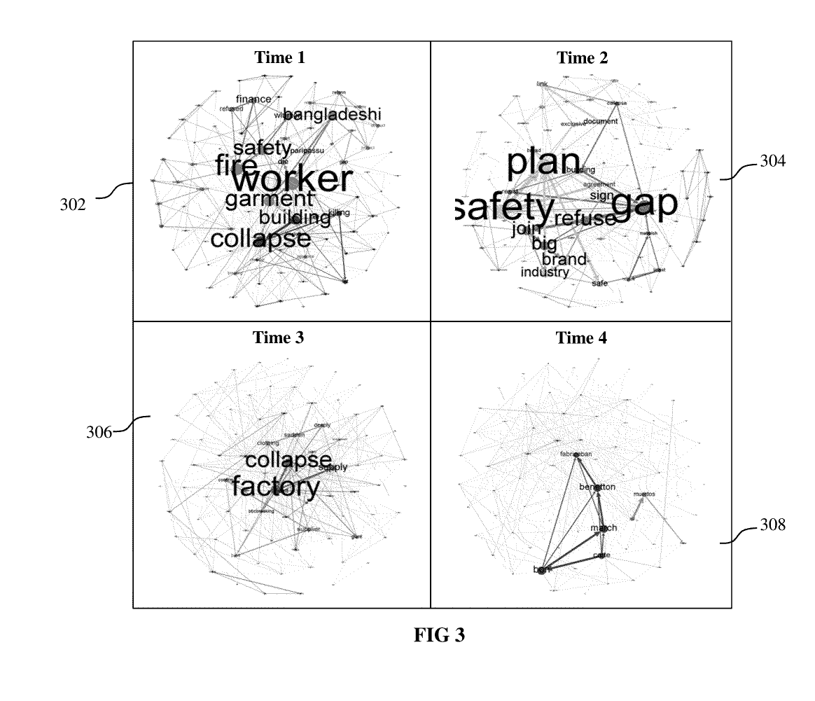

FIG. 3 illustrates evolution of enterprise risk related communities in accordance with an embodiment of the present invention.

For analysis of interaction data, the one or more communities comprising active users are connected across all the time periods, and one or more nodal graphs connecting clusters of individuals spread across the predetermined time period may be constructed. The one or more nodal graphs are shown in block 302, block 304, block 306, and block 308 that represent the connections between the one or more users and the one or more communities within a social network. The one or more nodal graphs may be displayed to the end users in order to facilitate the end users in tracking dynamic or fluctuating membership of users in a group or a cluster within the predetermined time period.

In one embodiment herein, the graphs may be displayed to the end users on the electronic devices. Each block shown in the figure (FIG. 3) illustrates a nodal graph for a community that is being evolved as a core community in different time periods. Block 302, block 304, block 306, and block 308 show dots and lines that represent connections between the users of the social data networks. The graphic representation also represents risks associated with an enterprise at predetermined time period. The smaller dots represent less number of connections, whereas the larger dots represent more number of connections of users participating in the discussion. For example, block 302 depicts evolution of enterprise risk related to a garment factory. Accordingly, various possible keywords relating to garment factory that the users of social data networks may use in their interaction data, can be seen in the graph of block 302. These keywords may include for example ‘worker’, ‘garment’, ‘factory’, ‘collapse’ etcetera. These graphs facilitate an end user in analyzing the dynamic structure of a social network and measuring the enterprise risks emanating from the one or more social networks.

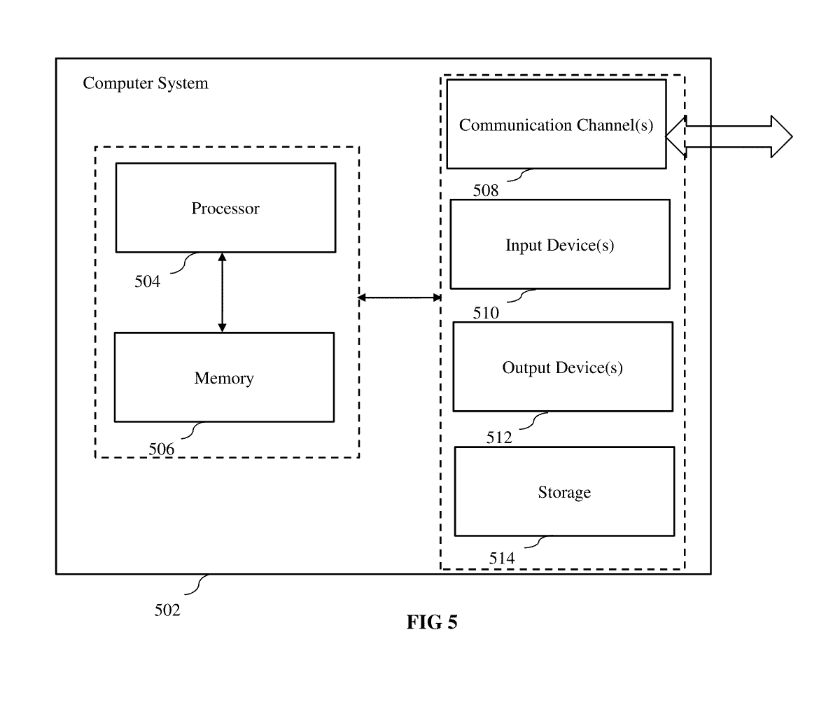

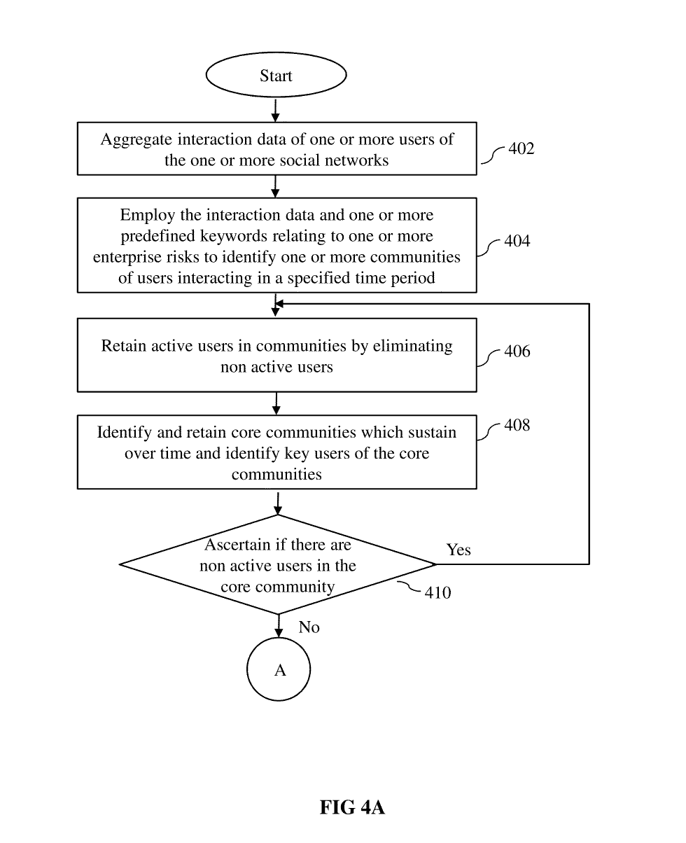

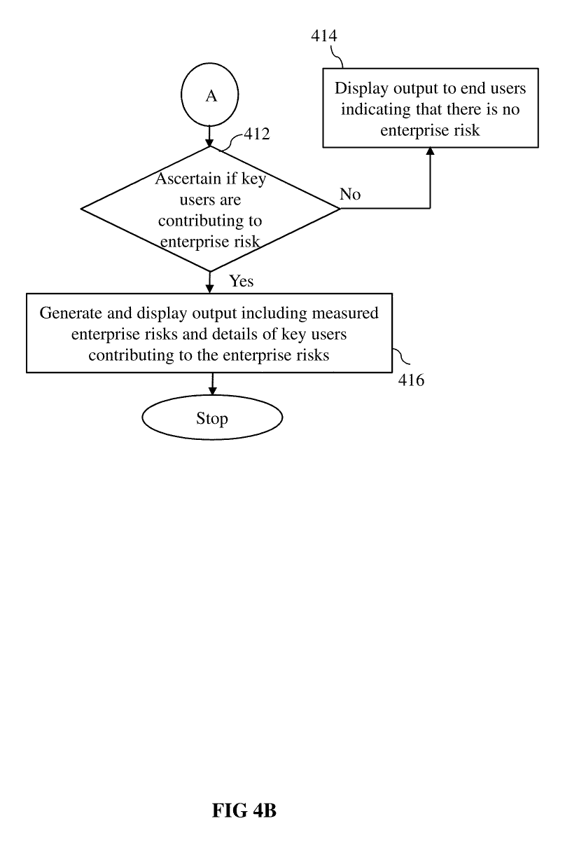

FIG. 4 represents a flowchart illustrating a method for identifying enterprise risks emanating from social networks in accordance with an exemplary embodiment of the present invention.

At step 402, interaction data of one or more users of the one or more social networks is aggregated. In an embodiment of the present invention, the one or more users access one or more social networks to provide interaction data via one or more communication devices. The one or more users access the one or more social networks for posting, commenting, blogging, sending messages, expressing, sharing thoughts on a subject matter, creating groups, creating communities or forums that link or connect people having common or similar interests. The one or more social networks are the risk data sources that include a plurality of online social networks, social media networks or systems, websites, and computer enabled systems including for example; Facebook, Twitter, Sina Weibo, and any other similar social networks or websites. Further, the one or more users access the one or more social networks using one or more communication devices including, but not limiting to, a personal computer (PC), a mobile phone, a Personal Digital Assistant (PDA), a smart phone, and any other communication device. Furthermore, the interaction data includes user interaction data and historical data pertaining to one or more enterprise risks, for example, information pertaining to defaming posts or internet libels for any company, organization, institution, products, brands; ratings or complains of a product; malpractices of any company, factory, and/or organization etcetera.

At step 404, the interaction data and one or more predefined keywords relating to one or more enterprise risks are employed to identify one or more communities of users interacting in a predetermined time period. In an embodiment of the present invention, the one or more keywords are predefined using taxonomy of one or more enterprise-risks-constructs along with one or more variables associated to the enterprise-risk-constructs and subsequently one or more keywords related to the variables. For example, an enterprise-risk-construct may include, ‘Operational Risk’, and the enterprise risk variable related to ‘Operational Risk may include ‘Product Risk’ which may depict malfunctioning of a product component. Therefore, the associated enterprise risk keywords for the above example may include ‘failure’, ‘slow’, ‘sucks’, ‘refund’, ‘return’, ‘unhappy’ etcetera. In one embodiment of the present invention, the one or more predefined keywords include new and updated keywords.

In one embodiment of the present invention, the interaction data is matched with the predefined keywords to perform risk analysis for a predetermined time period or time window, in order to identify one or more communities of users who contribute to enterprise risks in the predetermined time period.

At step 406, active users in the identified one or more communities are retained by eliminating non active users who interact the least in the predetermined time period. A threshold is set for identifying one or more communities comprising active users who contribute the most to the enterprise risk. In one embodiment of the present invention the threshold is based upon one or more factors including but not limited to the prescribed time, number of interaction data posted by the one or more users, relevancy of the interaction data with respect to the one or more predefined keywords, structure of the one or more social networks, and range of the one or more social networks.

At step 408, network centrality of the active users is measured to identify core community comprising one or more key users who are majorly involved in contributing to the enterprise risks in the predetermined time period. The one or more communities of users being dynamic in nature, have fluctuating number of users who join and leave a community in a predetermined time period. The dynamic network structure is measured by monitoring participation of members who can be active users or key users as explained above.

At step 410, an iterative check is performed to ascertain if there are non active users present and if non active users are identified, they are eliminated from the core community. Steps 408-410 are repeated for iterative elimination of non active users. The steps of eliminating non active users are repeated till there is stability in the number of active community individuals or users.

At step 412, a check is performed to ascertain if the key users are contributing to enterprise risks.

At step 414, if it is ascertained that the key users are not contributing to enterprise risks, then one or more end users are informed via an output display that there is no enterprise risk. The one or more end users are the authorized risk monitoring team or individuals who monitor the enterprise risks and obtain the output through one or more electronic devices.

At step 416, if it is ascertained that the key users are contributing to enterprise risks, then the measured risk is displayed to the end user and details of key users contributing to enterprise risks are also sent to the end-users. The measured enterprise risk may include for example; a product recall, or a quality problem with product.

FIG. 5 illustrates an exemplary computer system in which various embodiments of the present invention may be implemented.

The computer system 502 comprises a processor 504 and a memory 506. The processor 504 executes program instructions and may be a real processor and/or a virtual processor. The computer system 502 is not intended to suggest any limitation as to scope of use or functionality of described embodiments. For example, the computer system 502 may include, but is not limited to, a general-purpose computer, a programmed microprocessor, a micro-controller, a peripheral integrated circuit element, and other devices or arrangements of devices that are capable of implementing the steps that constitute the method of the present invention. In an embodiment of the present invention, the memory 506 may store software for implementing various embodiments of the present invention. The computer system 502 may have additional components including one or more communication channels 508, one or more input devices 510, one or more output devices 512, and storage 514. An interconnection mechanism (not shown) such as a bus, controller, or network, interconnects the components of the computer system 502. In various embodiments of the present invention, operating system software provides an operating environment for various software being executed in the computer system 502, and manages different functionalities of the components of the computer system 502.

The communication channel(s) 508 allow communication over a communication medium to various other computing entities. The communication medium provides information such as program instructions, or other data in a communication media. The communication media includes, but is not limited to, wired or wireless methodologies implemented with an electrical, optical, RF, infrared, acoustic, microwave, Bluetooth or other transmission media.

The input device(s) 510 may include, but not limited to, a keyboard, mouse, pen, joystick, trackball, a voice device, a scanning device, or any another device that is capable of providing input to the computer system 502. In an embodiment of the present invention, the input device(s) 510 may be a sound card or similar device that accepts audio input in analog or digital form. The output device(s) 512 may include, but not limited to, a user interface on CRT or LCD, printer, speaker, CD/DVD writer, or any other device that provides output from the computer system 502.

The storage 514 may include, but not limited to, magnetic disks, magnetic tapes, CD-ROMs, CD-RWs, DVDs, flash drives or any other medium which can be used to store information and can be accessed by the computer system 502. In various embodiments of the present invention, the storage 514 contains program instructions for implementing the described embodiments.

The present invention may suitably be embodied as a computer program product for use with the computer system 502. The method described herein is typically implemented as a computer program product, comprising a set of program instructions which is executed by the computer system 502 or any other similar device. The set of program instructions may be a series of computer readable codes stored on a tangible medium, such as a computer readable storage medium (storage 514), for example, diskette, CD-ROM, ROM, flash drives or hard disk, or transmittable to the computer system 502, via a modem or other interface device, over either a tangible medium, including but not limited to optical or analogue communications channel(s) 508. The implementation of the invention as a computer program product may be in an intangible form using wireless techniques, including but not limited to microwave, infrared, Bluetooth or other transmission techniques. These instructions can be preloaded into a system or recorded on a storage medium such as a CD-ROM, or made available for downloading over a network such as the internet or a mobile telephone network. The series of computer readable instructions may embody all or part of the functionality previously described herein.

The present invention may be implemented in numerous ways including as an apparatus, method, or a computer program product such as a computer readable storage medium or a computer network wherein programming instructions are communicated from a remote location.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims.

We claim:

1. A computer-implemented method using program instructions stored in a memory and executed by a processor for identifying one or more enterprise risks emanating from one or more social networks, the method comprising the steps of:
aggregating interaction data of one or more users of the one or more social networks;
employing the interaction data and one or more predefined keywords relating to the one or more enterprise risks to identify one or more communities of users interacting in a predetermined time period;
eliminating iteratively from the one or more communities, one or more non-active users interacting least in the predetermined time period;
analyzing the interaction data of remaining users for identifying the one or more enterprise risks during the predetermined time period.

2. The computer-implemented method of claim 1, wherein the one or more predefined keywords are created using taxonomy of the one or more enterprise risks.

3. The computer-implemented method of claim 1, wherein the one or more communities comprise groups and subgroups of users, and individual users.

4. The computer-implemented method of claim 3, wherein the groups and subgroups of users, and individual users are dynamic in number.

5. The computer-implemented method of claim 3, wherein the groups and subgroups of users are linked to each other based on common user-interests.

6. The computer-implemented method of claim 1, wherein analyzing the interaction data comprises the steps of:
monitoring pattern of the interaction data of users over the predetermined time period, and
identifying and monitoring one or more profiles of users within the one or more communities that are of potential risk to one or more enterprises.

7. The computer-implemented method of claim 1, wherein the remaining users are identified as active users by setting a threshold.

8. The computer-implemented method of claim 7, wherein setting of the threshold is based upon one or more factors including but not limited to the predetermined time period, number of the interaction data posted by the one or more users, relevancy of the interaction data with respect to the one or more predefined keywords, structure of the one or more social networks, and range of the one or more social networks.

9. The computer-implemented method of claim 1, wherein the one or more enterprise risks are identified by creating graphs that depict pattern of the interaction data of users within the one or more communities.

10. A system for identifying one or more enterprise risks emanating from one or more social networks comprising:
a processor for executing program instructions stored in a memory to configure:
a data integrator for aggregating interaction data of one or more users of the one or more social networks,
a keyword module for providing one or more predefined keywords relating to one or more enterprise risks,
a data analysis module for: employing the interaction data and the one or more predefined keywords to identify one or more communities of users interacting in a predetermined time period, and eliminating iteratively from the one or more communities, one or more non-active users interacting least in the predetermined time period, and
a risk identifying module for analyzing the interaction data of remaining users to identify the one or more enterprise risks during the predetermined time period.

11. The system of claim 10, wherein the one or more predefined keywords are created using taxonomy of the one or more enterprise risks.

12. The system of claim 10, wherein the one or more communities comprise groups and subgroups of users, and individual users.

13. The system of claim 12, wherein the groups and subgroups of users, and individual users are dynamic in number.

14. The system of claim 12, wherein the groups and subgroups of users are linked to each other based on common user-interests.

15. The system of claim 10, wherein the data analysis module is further configured to:
monitor pattern of the interaction data of users over the predetermined time period, and
identify and monitor one or more profiles of users within the one or more communities that are of potential risk to one or more enterprises.

16. The system of claim 11, wherein the remaining users are identified as active users by setting a threshold.

17. The system of claim 16, wherein the threshold is based upon one or more factors including but not limited to the prescribed time, number of the interaction data posted by the one or more users, relevancy of the interaction data with respect to the one or more predefined keywords, structure of the one or more social networks, and range of the one or more social networks.

18. The system of claim 19, wherein the one or more enterprise risks are identified by creating graphs that depict behaviors and pattern of the interaction data of users within the one or more communities.

19. A computer program product for identifying one or more enterprise risks emanating from one or more social networks, the computer program product comprising:
a non-transitory computer-readable medium having computer-readable program code stored thereon, the computer-readable program code comprising program instructions that when executed by a processor, cause the processor to:
aggregate interaction data of one or more users of the one or more social networks;
employ the interaction data and one or more predefined keywords relating to the one or more enterprise risks to identify one or more communities of users interacting in a predetermined time period;
eliminate iteratively from the one or more communities, one or more non-active users interacting least in the predetermined time period;
analyze the interaction data of remaining users for identifying the one or more enterprise risks during the predetermined time period.

20. The computer program product of claim 19, wherein the program instructions further cause the processor to:
monitor pattern of the interaction data of users over the predetermined time period, and
identify and monitor one or more profiles of users within the one or more communities that are of potential risk to one or more enterprises.
